(19) United States
(12) Patent Application Publication
(10) Pub. No.: US 2009/0125232 A1
(43) Pub. Date: May 14, 2009

(54) Navigation System and Application Thereof

(75) Inventors: Chi-Hsien Chiu, Taipei (TW); Feng-Cheng Yang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTeK Computer Inc., Taipei (TW)

(21) Appl. No.: 12/243,369

(22) Filed: Oct. 1, 2008

(30) Foreign Application Priority Data
Nov. 9, 2007 (TW) 96142539

(51) Int. Cl. G01C 21/32

(52) U.S. Cl. 701/208

(57) ABSTRACT

A navigation system is disclosed. The navigation system includes a display element, a storage element and a reverse switch. The display element displays a position image, wherein the position image is generated according to position data received by the navigation system. The storage element stores an image-reversing process. Once the reverse switch is pressed, utilize the image-reversing process to make the display element display a reversed position image of the position image.

### RELATED APPLICATIONS

This application claims priority to Taiwan Application Serial Number 96142539, filed Nov. 9, 2007, which is herein incorporated by reference.

### BACKGROUND

1. Field of Invention

The present invention relates to a navigation system. More particularly, the present invention relates to a navigation system for displaying a reversed position image.

2. Description of Related Art

Navigation systems typically include GPS navigation devices. According to-global positioning signals received by the GPS navigation device, position-coordinate of the navigation system is obtained. Furthermore, a navigation position image is selected from a database according to the position-coordinate of the navigation system. In addition, after driver inputs a destination, a suggested path is generated through the navigation software to give directions to the driver. The navigation system is often installed in the dashboard of a car or fixed in a frame. The driver must turn or lower his/her head when trying to read the navigation information displayed on the navigation system. However, it is very dangerous for the driver to remove his/her attention from the road while driving.

### SUMMARY

Therefore, this invention provides a navigation system to make reading navigation information without turning or lowering head.

According to one embodiment of this invention, a navigation system includes a display element, a storage element and a reverse switch. The display element displays a position image, wherein the position image is generated according to position data received by the navigation system. The storage element stores an image-reversing process. Once the reverse switch is pressed, utilize the image-reversing process to reverse the position image to generate a reversed position image and the display element displays the reversed position image.

According to another embodiment of this invention, a display method includes the following steps: receiving position data of a navigation device, obtaining a position image according to the position data, reversing the position image to obtain a reversed position image, and displaying the reversed position image on a display element of the navigation device.

Above all, the navigation system and method thereof can make the driver read navigation information without turning or lowering head. The navigation device of the navigation system doesn't need to change the hardware structure to display the reversed position image. Therefore, the navigation device can be produced by the current production line. Furthermore, the navigation device may display a normal position image as other normal portable navigation devices (PND) or display a reversed position image after pressing the reverse switch.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a navigation system according to one embodiment of this invention;

FIG. 2 illustrates the navigation system of FIG. 1 set-up on a car;

FIG. 3A, FIG. 3B and FIG. 3C illustrate diagrams of 2×2 pixels on a display element of a navigation device respectively according to another embodiment of this invention; and

FIG. 4 is a flow diagram of a display method 300 according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

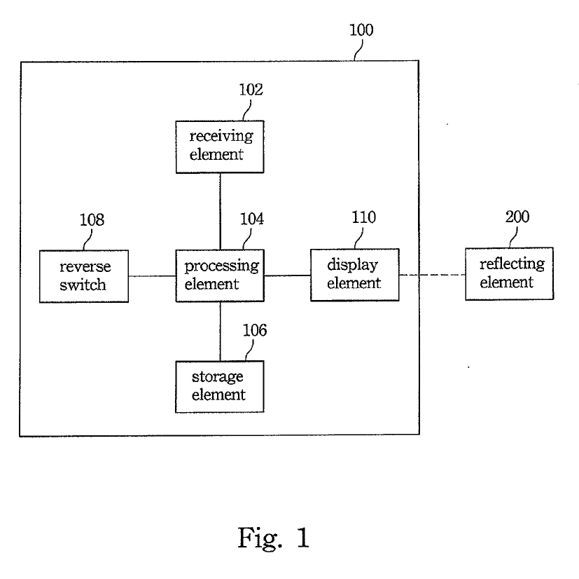

FIG. 1 is a block diagram of a navigation system according to one embodiment of this invention. A navigation device 100 of the navigation system includes a receiving element 102, a process element 104, a memory (or a storage element) 106, a reverse switch (or a reverse button) 108 and a display element 110. The receiving element 102 receives the position data. In detail, the receiving element 102 may be an antenna to receive global positioning signals to be the position data. The receiving element 102 may be a user interface, such as a mouse, a keyboard, a touch screen or any other user interface. In other words, a user may input the position data to the receiving element 102. Moreover, the position data may be a current position-coordinate, a place name (such as Taipei), or any other data for positioning the navigation device 100. The processing element 104 processes the position data to obtain the position image. In detail, the processing element 104 selects the position image from the memory (or the storage element) 106 according to the position data. The position image may be a navigation map or a street view around the position of the navigation device 100.

Once the reverse switch (or the reverse button) 108 is pressed, the reverse switch (or the reverse button) 108 transmits a reverse signal to the processing element 104 to make the processing element 104 reverse the position image through an image-reversing process, wherein the image-reversing process may be stored in the memory (or the storage element) 106. The image-reversing process may reverse the position image from right to left or from top to bottom (the image-reversing process will be described in the following paragraph). The display element 110 displays the reversed position image. In addition, a reflecting element 200 may reflect the reversed position image, to make the user see the normal position image (non-reversed position image).

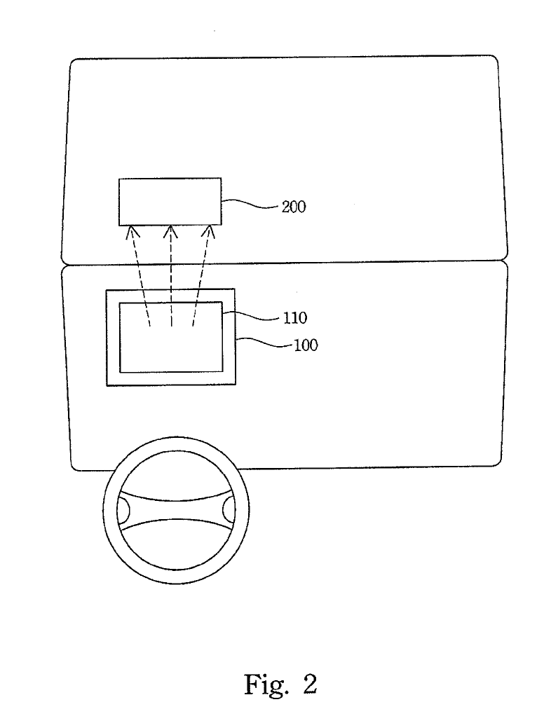

FIG. 2 illustrates the navigation system of FIG. 1 set-up on a car. The navigation device 100 is put on a surface under the windshield of the car. Once the display element 110 of the navigation device displays a reversed position image, the reflecting element 200 may reflect the reversed position image, which makes the reversed position image reversed to a normal position image (non-reversed position image). The reflecting element 200 may be a deep color transparent sticker installed on the windshield or a mirror combined with the navigation device 100. Therefore, the driver may see the normal position image (non-reversed position image) through the reflecting element 200 without turning or lowering his/her head, which may makes the driver drive more safely.

In practical, an image is input into a display element pixel by pixel. The first pixel of the image to be input is top-left pixel of the image, and the pixel sequence of the image is from left to right and from top to bottom. When the display element displays an image normally, the display element displays the position image from a top-left pixel of the display element and the display element displays pixels of the position image from left to right and from top to bottom. When the reverse switch is pressed, the image-reversing process may make the display element display the image right to left or top to down. In practical, to display the image right to left on the display element, the display element displays the position image from a top-right pixel of the display element and the display element displays pixels of the position image from right to left and from top to bottom. On the other hand, to display the image top to bottom on the display element, the display element displays the position image from a left-bottom pixel of the display element and the display element displays pixels of the position image from left to right and from bottom to top.

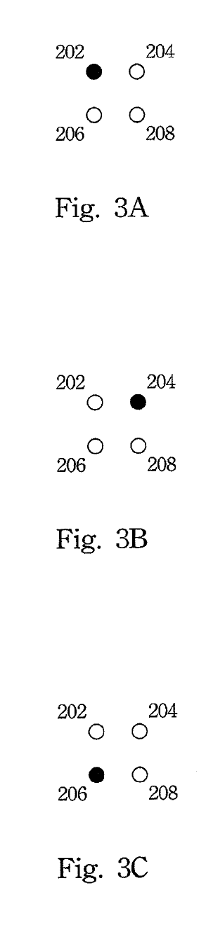

FIG. 3A, FIG. 3B and FIG. 3C illustrate diagrams of 2×2 pixels on a display element of a navigation device respectively according to this invention. For example, an image is input into the display element, wherein the pixel sequence of the image is black, white, white and white. Referring to FIG. 3A, the display element displays the image normally with black, white, white and white on pixels 202, 204, 206 and 208 of the display element respectively. Referring to FIG. 3B, the display element displays the image reversed right to left by displaying with black, white, white and white on pixels 204, 202, 208 and 206 of the display element respectively. In other words, the display element displays the position image from the top-right pixel 204 and the display element displays pixels of the position image from right to left and from top to bottom. Referring to FIG. 3C, the display element displays the image reversed top to bottom by displaying with black, white, white and white on pixels 206, 208, 202 and 204 of the display element respectively. In other words, the display element displays the position image from the left-bottom pixel 206 and the display element displays pixels of the position image from left to right and from bottom to top. Therefore, the navigation device can display the reversed position image by changing the start-scanning point and the scanning sequence.

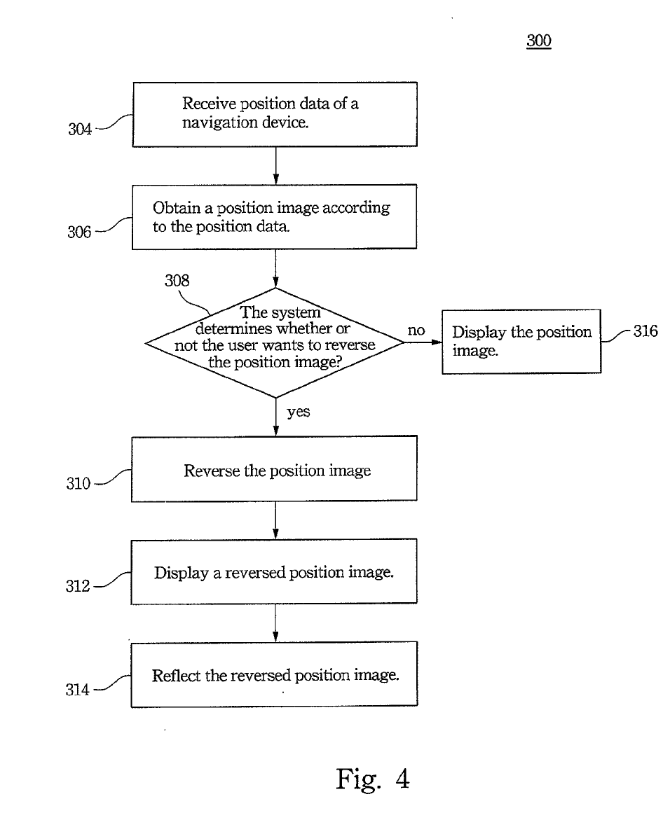

FIG. 4 is a flow diagram of a display method 300 according to one embodiment of this invention. The display method 300 can display a reversed position image for navigation. Refer to FIG. 1, FIG. 2 and FIG. 4 at the same time. The display method 300 begins with the step 304 in which position data of a navigation device 100 is received by a receiving element 102. The position data may be a current position-coordinate, a place name (such as Taipei), or any other data for positioning the navigation device.

In the step 306, obtain a position image according to the position data. In detail, the processing element 104 may select the position image from the memory (or the storage element) 106. The position image may be a navigation map or a street view around the position of the navigation device.

In the step 308, the system determines whether or not the user wants to reverse the position image. In practical, the system determines whether or not the user wants to reverse the position image through the reverse switch (or the reverse button) 108.

In the step 310, when the system determines that the user wants to reverse the position image, reverse the position image. In practical, once the reverse switch (or the reverse button) 108 is pressed, the processing element 104 may reverse the position image from right to left or from top to bottom.

In the step 312, display the reversed position image of the position image on a display element 110 of the navigation device 100. Then, in the step 314, reflect the reversed position image. In practical, the reversed position image displayed by the display element 110 is reflected by the reflecting element 200, which makes the reversed position image reverse to a normal position image (non-reversed position image). Therefore, the driver may see the normal position image (non-reversed position image) through the reflecting element 200.

In the step 316, when the system determines that the user doesn't want to reverse the position image, display the position image. In practical, if the reverse switch (or the reverse button) 108 is not pressed, the display element 110 displays the position image. In other words, the driver may see the position image through the navigation device directly.

Several different advantages exist with these and other embodiments. The navigation system and method thereof can make the driver read navigation information displayed on the navigation system possible without turning or lowering head. The navigation device of the navigation system doesn't need to change the hardware structure to display the reversed position image. Therefore, the navigation device can be produced by the current production line. Furthermore, the navigation device may display a normal position image as other normal portable navigation devices (PND) or display a reversed position image after pressing the reverse switch.

Although the present invention has been described in considerable detail with reference to certain embodiments thereof, other embodiments are possible. Therefore, their spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A navigation system comprising:
a display element for displaying a position image, wherein the position image is generated according to position data received by the navigation system;
a storage element for storing an image-reversing process; and
a reverse switch, wherein the image-reversing process reverses the position image and displays a reversed position image on the display element once the reverse switch is pressed.

2. The navigation system of claim 1, further comprising:
a receiving element for receiving the position data; and
a processing element for processing the position data to obtain the position image.

3. The navigation system of claim 2, wherein the receiving element is an antenna.

4. The navigation system of claim 1, wherein the position data is a current position-coordinate of the navigation system.

5. The navigation system of claim 1, further comprising:
a reflecting element for reflecting the reversed position image.

6. The navigation system of claim 5, wherein the reflecting element is a deep color transparent sticker.

7. The navigation system of claim 5, wherein the reflecting element is a mirror.

8. The navigation system of claim 1, wherein the position image is a map.

9. The navigation system of claim 1, wherein the image-reversing process reverses the position image right to left to obtain the reversed position image.

10. The navigation system of claim 9, wherein the display element displays the position image from a top-left pixel of the display element originally, the display element displays pixels of the position image from left to right and from top to bottom originally, and once the reverse switch is pressed, the display element displays the position image from a top-right pixel of the display element and the display element displays pixels of the position image from right to left and from top to bottom.

11. The navigation system of claim 1, wherein the image-reversing process reverses the position image top to bottom.

12. The navigation system of claim 11, wherein the display element displays the position image from a top-left pixel of the display element originally, the display element displays pixels of the position image from left to right and from top to bottom originally, and once the reverse switch is pressed, the position image from a left-bottom pixel of the display element and the display element displays pixels of the position image from left to right and from bottom to top.

13. A display method comprising:
receiving position data of a navigation device;
obtaining a position image according to the position data;
reversing the position image to obtain a reversed position image; and
displaying the reversed position image on a display element of the navigation device.

14. The display method of the claim 13, further comprising:
reflecting the reversed position image.

15. The navigation method of claim 14, wherein reflecting the reversed position image uses a deep color transparent sticker.

16. The navigation method of claim 13, wherein reflecting the reversed position image uses a mirror.

17. The display method of the claim 13, wherein the position image is a map.

18. The display method of the claim 13, wherein reversing the position image comprises:
reversing the position image right to left.

19. The display method of the claim 18, wherein reversing the position image comprises:
reversing the position image by displaying the position image from a top-right pixel of the display element of the navigation device and displaying pixels of the position image from right to left and from top to bottom, wherein the display element displays the position image from a top-left pixel of the display element and the display element displays pixels of the position image from left to right and from top to bottom before reversing the position image.

20. The display method of the claim 13, wherein reversing the position image comprises:
reversing the position image top to bottom.

21. The display method of the claim 20, wherein reversing the position image comprises:
reversing the position image by displaying the position image from a left-bottom pixel of the display element of the navigation device and displaying pixels of the position image from left to right and from bottom to top, wherein the display element displays the position image from a top-left pixel of the display element and the display element displays pixels of the position image from left to right and from top to bottom before reversing the position image.
